(19) United States
(12) Patent Application Publication
(10) Pub. No.: US 2004/0153677 A1
(43) Pub. Date: Aug. 5, 2004

(54) Self-generator device of portable computer

(76) Inventor: Ming-Zhen Liao, Yunlin (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/358,234

(22) Filed: Feb. 5, 2003

(51) Int. Cl. G06F 1/26

(52) U.S. Cl. 713/300

(57) ABSTRACT

A self-generator device of a portable computer mainly comprises a manual generator installed inside said portable computer, said manual generator having a control bar extending outside a case of said portable computer and coupling an output of said manual generator to a charging circuit of said portable computer. When said rechargeable battery of said portable computer is low, turning said control bar to enable said manual generator and to provide power to charge said rechargeable battery, which provides enough power to said portable computer for operation, thereby preventing said portable computer from being inoperable at critical times due to exhausted battery power.

### BACKGROUND OF THE INVENTION

1. Field of the Invention

The present invention is related to a self-generator device of portable computer, and more particularly, to a manual generator device which provides power to the portable computer when the battery is low, thereby allowing user to work with the portable computer anywhere at anytime.

2. Description of the Prior Art

IT technology evolves quickly, and manufacturers roll out a variety of computer products for users to boost the user adoption rate of computer products even higher everyday, especially in the notebook field, as the high price tag becoming more affordable to consumers.

In addition to affordable prices, the most important factor for the prevalence of portable computers lies in its excellent portability. In other words, user can carry a notebook with him/her to work anywhere at anytime without any concern, thus improving mobility and efficiency of his/her work.

In order to bring notebook into full play, sufficient power supply is one of the most critical factors. Most notebook users have encountered the following situation: although user has done charging his/her notebook at home, he/she soon finds out the lifetime of the battery is only a few hours when the notebook is unplugged, that is not enough to handle most of the works. If the battery is low, user has to look for a power supply to charge the battery lest the notebook stops working and loses data. If the user is in the municipal area, finding an electrical outlet is not hard; but in the rural area or some remote places, it could mean a real problem. Therefore, most notebook users still put their notebooks in the office or at home as a replacement to desktop PCs, the functionality of notebook is not fully realized.

Recently tablet PC emerging as another type of portable computers, it has the size of a LCD display and a compact thickness, making it easy for user to carry it along in a handbag or suitcase due to its high portability. Nevertheless, although tablet PC generally consumes less power than notebook, it could not work for long, since the battery technology still showing no breakthrough in the lifetime of battery, especially in the rechargeable field. In consideration of the compact form factor of tablet PC, the capacity of rechargeable battery used herein is not able to handle routine work. Actually, no matter how high the capacity of rechargeable battery is, the portable computer becoming inoperable when it runs out of battery power. Therefore, how to provide enough power to keep the portable computer running has been a critical challenge to the industry. In view of the above-described difficulty and deficiency in using the portable computer, the inventor of this invention has proposed a mechanism, which is built in the portable computer and controlled manually to provide instant power to the battery. After long terms of constant effort in research, the inventor of the present invention has consequently developed “A Self-Generator Device of Portable Computer” to solve the foregoing problem.

### SUMMARY OF THE INVENTION

It is an object of the present invention to provide a self-generator device of portable computer; the self-generator device can charge user's portable computer immediately to keep the portable computer operating. Even in rural area or any remote places, the self-generator device is still able to generate power to charge the battery, letting user to fully utilize the capability of portable computer.

It is another object of the present invention to provide a self-generator device of portable computer having a simple and easy-to-use structure for users.

In order to achieve the above-mentioned objectives, the present invention provides a portable computer comprising a manual generator installed therein, wherein user can control the manual generator to charge the battery of the portable computer at anytime to make things smooth. The manual generator is installed inside the portable computer, comprising a control bar extending outside the case of the portable computer and coupling an output of the manual generator to a charging circuit of the portable computer. When the rechargeable battery is low, user can turn the control bar directly to enable the manual generator to charge the rechargeable battery, which provides enough power to the portable computer for operation.

### BRIEF DESCRIPTION OF THE DRAWINGS

The drawings disclose an illustrative embodiment of the present invention which serves to exemplify the various advantages and objects hereof, and are as follows:

FIG. 1 shows a constructing block diagram of the present invention;

FIG. 2 shows a principal generator device structure of the present invention;

FIG. 3 shows a first embodiment of the present invention;

FIG. 4 shows a second embodiment of the present invention; and

FIG. 5 shows a third embodiment of the present invention.

### DETAILED DESCRIPTION OF THE PREFERRED EMBODIMENT

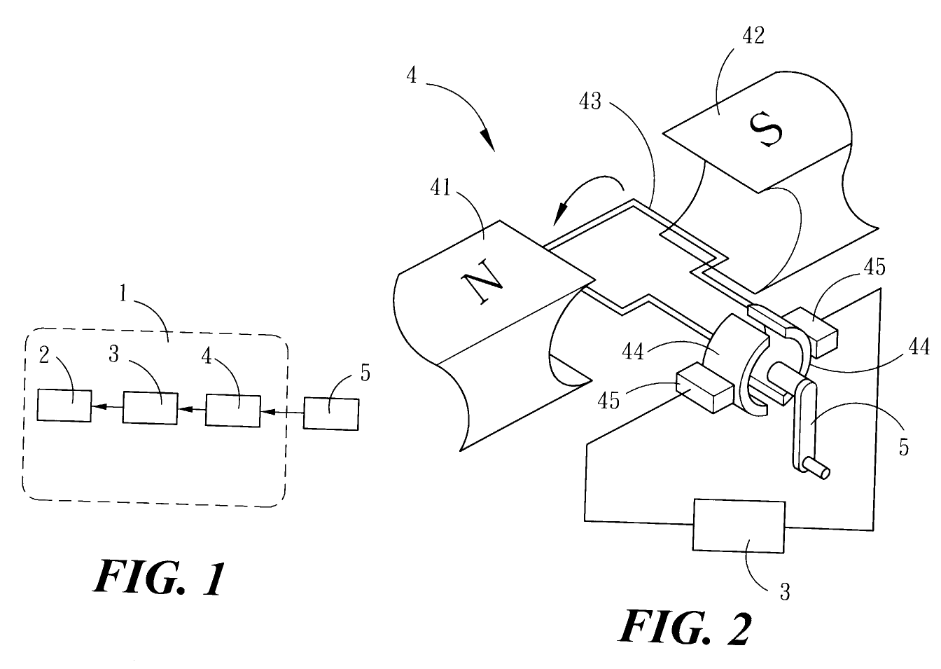

Please refer to FIG. 1, a self-generator device of portable computer 1 is disclosed in the present invention, wherein portable computer 1 can be tablet PC 1a or notebook 1b, or any portable type computers. Whatever the portable computer 1 would be, an included rechargeable battery 2 is required, and the rechargeable battery 2 coupling to an external power supply via a charging circuit 3. Preferably, the portable computer 1 disclosed in the present invention comprises a manual generator 4 therein, a control bar 5 of the manual generator 4 extending outside the case of the portable computer 1. When the rechargeable battery 2 is low, user can turn the control bar 5 directly to enable the manual generator 4 to charge the rechargeable battery 2 through charging circuit 3, thereby providing enough power to the portable computer when needed.

Please refer to FIG. 2, preferably, the manual generator 4 is a DC (direct current) generator, which comprises a permanent magnetic field formed by a N magnetic pole 41 and a S magnetic pole 42; an armature 43 installed inside the permanent magnetic field, the armature 43 having both ends coupling to a semicircular commutator 44. On the outer rim of the commutator 44, a brush 45 is in contact of the commutator 44, and the brush 45 coupling to the charging circuit 3 via conducting material. When user turns the control bar 5, the armature 43 rotating in the permanent magnetic field to interact with the magnetic line of force to generate power, which in turn output by the commutator 44 as direct current. Those who skilled in the art should know the DC generator can be replaced by AC (alternating current) generator using rectifier to output direct current, for the sake of brevity, it is not described herein.

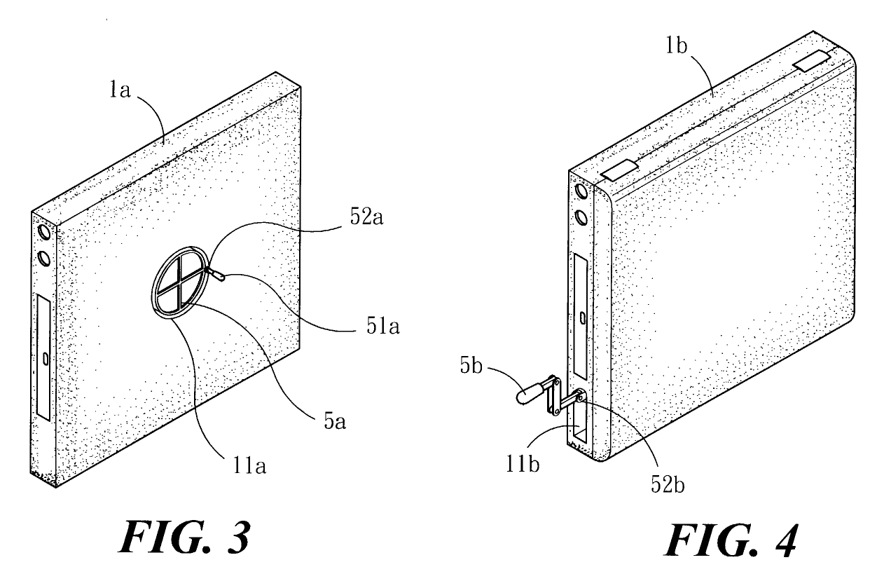

FIG. 3 shows an embodiment of the present invention used in tablet PC 1a, wherein the control bar 5 is a turntable 5a. A handle 51a is installed on the perimeter of the turntable 5a, thereby letting user to control the turntable 5a through the handle 51a to generate power. In order to enhance the artistic design and to facilitate convenience, a compartment 11a of the tablet PC 1a is designed to receive the turntable 5a, wherein the surface of the turntable 5a is on the same plane as the surface of tablet PC 1a. The handle 51a connects to the turntable 5a via a shaft 52a, user can bend the shaft 52a to fold the handle 51a for storage.

FIG. 4 shows an embodiment of the present invention used in notebook 1b, wherein the control bar 5 is a crank 5b, which allows user to turn the crank 5b to generate power. Same as in FIG. 3, the crank 5b comprises a shaft 52b rotated around a turning point to fold the crank 5b into a minimum volume. And a compartment 11b is installed at a suitable place on the notebook 1b, the compartment 11b receiving the folded crank 5b therein for the integrity of the notebook 1b.

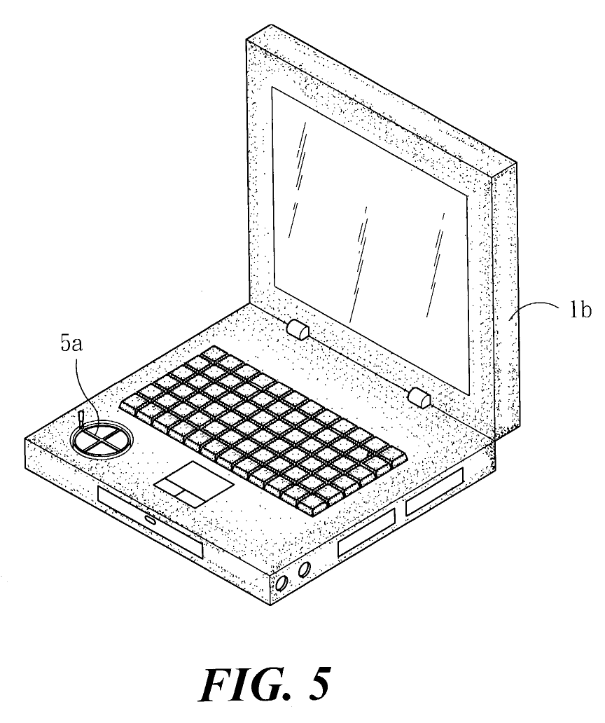

The aforementioned turntable 5a or crank 5b are traditional rotation control mechanisms, which can be used in either tablet PC 1a or notebook 1b and modified according to the design of the portable computer 1 in order not to affect the appearance of the portable computer and its usability. As shown in FIG. 5, the turntable 5a is installed on the working platform of the notebook 1b. When user notices the battery is low, he/she can turn the turntable 5a immediately to charge the battery of notebook 1b, thereby preventing the notebook from shutting down and providing smooth operation for user. Furthermore, other rotation mechanisms are applicable in the present invention to provide charging function, no limited to the embodiments described above.

Compared to traditional techniques, the self-generator device of portable computer disclosed in the present invention allows user to charge his/her portable computer at any time even in remote districts, the self-generator device preventing the portable computer from being inoperable at critical times due to exhausted battery power to assure its usability. Besides, the self-generator device of portable computer disclosed in the present invention is easy to operate for everyone, even the elders or children, that helps to promote the product and for manufactures to implement the function.

Many changes and modifications in the above described embodiment of the invention can, of course, be carried out without departing from the scope thereof Accordingly, to promote the progress in science and the useful arts, the invention is disclosed and is intended to be limited only by the scope of the appended claims.

What is claimed is:

1. A self-generator device of a portable computer, said portable computer comprising a rechargeable battery and a charging circuit, the present invention being characterized in:
said portable computer having a manual generator installed therein, said manual generator having a control bar extending outside a case of said portable computer and coupling an output of said manual generator to a charging circuit of said portable computer.

2. The self-generator device as recited in claim 1, wherein said control bar is a turntable having a handle installed thereon, said handle being controlled manually to drive said turntable to turn around.

3. The self-generator device as recited in claim 2, wherein said handle having a shaft connected to said turntable to fold said handle for better disposal.

4. The self-generator device as recited in claim 1, wherein said control bar is a crank having a shaft rotated around a turning point to fold said crank into a minimum volume.

5. The self-generator device as recited in claim 1, wherein said case of said portable computer comprising a compartment to receive said control bar therein.

6. The self-generator device as recited in claim 2, wherein said case of said portable computer comprising a compartment to receive said control bar therein.

7. The self-generator device as recited in claim 4, wherein said case of said portable computer comprising a compartment to receive said control bar therein.
